(19) United States
(12) Patent Application Publication
(10) Pub. No.: US 2015/0208634 A1
(43) Pub. Date: Jul. 30, 2015

(54) Collapsible Table and Fishing Rod Holder Device with Storage

(71) Applicants: William Box, Brentwood, NY (US); Linda Box, Brentwood, NY (US)

(72) Inventors: William Box, Brentwood, NY (US); Linda Box, Brentwood, NY (US)

(21) Appl. No.: 14/482,383

(22) Filed: Sep. 10, 2014

Related U.S. Application Data
(60) Provisional application No. 61/900,150, filed on Nov. 5, 2013.

(51) Int. Cl. A01K 97/10; A47B 3/06; A47B 13/02; A47B 13/16; A01K 99/00; A47B 13/08

(52) U.S. Cl. CPC A01K 97/10; A01K 99/00; A47B 13/088; A47B 13/023; A47B 13/16; A47B 3/06

(57) ABSTRACT

Provided is a combination fishing rod holder and table. The device has a central shaft configured to hold fishing rod handles, beach umbrellas and other long cylindrical objects. An auger disposed on the end of the central shaft is driven into the sand and a collapsible tabletop is then secure to the central shaft. The tabletop features multiple beverage container holder elements and a pair of storage drawers. The drawers may be lockable to help secure items left therein. Fishers can place the handle of a fishing rod in the central shaft and use a clamping dial to secure the rod in place. Food and beverage items can then be enjoyed on the tabletop surface while waiting for fish to bite.

### CROSS REFERENCE TO RELATED APPLICATION

This application claims the benefit of U.S. Provisional Application No. 61/900,150 filed on Nov. 5, 2013. The above-identified patent application is herein incorporated by reference in its entirety to provide continuity of disclosure.

### BACKGROUND OF THE INVENTION

1. Field of the Invention

The present invention relates to portable furniture. More particularly, it relates to a collapsible table that incorporates a fishing rod holder into the singular table support. The table also includes cup holders and sliding drawers to enable storage of beverages, food items and loose articles. Surf fisherman will appreciate the invention's sand augur, which enables the device to be anchored into a beachfront near the surf.

Surf fishing is a sport involving the casting of a baited fishing line into the ocean surf to catch fish. Tides change around dawn and dusk, stirring up the sand and water near the shore, and consequently making it difficult for fish to see. During these times of turbulent surf, larger fish come into the shallow waters to feed on smaller fish that are partially blinded by the sand and silt in the water. After the tide change settles and the surf clears the fish retreat to deeper waters. In general, the best time to engage in surf fishing is during the changing tides near dawn or dusk, because the fish may be become easily confused in the cloudy water and attack baited lines eagerly.

Fishers who surf fish during midday and afternoon can face extensive wait periods between casting and hooking a fish, as they wait for fish hungry enough to grab the bait despite the clear vision afforded by the settled surf. To avoid tiring their arms and upper bodies by holding the fishing rod, fishers will drive a section of pipe into the sand and place the non-working end of the rod into the pipe. In this way, the rod is held upright, with the line free to move in the surf. The fisher can then sit down to wait until a fish is hooked.

To pass the time while fishing, fishers often kick back in outdoor chairs, eat and drink, and chat with friends. Coolers packed with picnic lunches and cold drinks may be hauled down tot eh beach and used as makeshift tables. Some coolers even have recesses in their lids for retaining a beverage container. But the beverage must be lifted in order to access the contents of the cooler, and there is rarely enough available space on the cooler surface to place a number of food items.

Additionally, these coolers do not provide secure storage of personal items. If a fisher needs to return to his or her vehicle to retrieve items, or leave the fishing area to use the restroom, they will not wish to carry all their accouterment with them. As such, secure storage of smaller items is advantageous.

A portable table suitable for use in sand and able to hold food and beverages, as well as securing personal items is needed. The present invention addresses this need by providing a collapsible table that employs a fishing rod holder as a central support. The table also includes beverage cup holders and sliding drawers for holding personal items, lures, and other small objects.

2. Description of the Prior Art

Devices have been disclosed in the prior art that relate to fishing rod support devices. These include devices that have been patented and published in patent application publications. These devices generally relate to rod holders that can be secured to sand or support structures. The following is a list of devices deemed most relevant to the present disclosure, which are herein described for the purposes of highlighting and differentiating the unique aspects of the present invention, and further highlighting the drawbacks existing in the prior art.

Chestnut, U.S. Pat. No. 3,344,551 discloses a walking stick shaped fishing rod holder with an attached bait box. The device has a crook at an upper end and a pointed lower end suitable for driving into soft sand. A cylindrical fishing rod holder is secured to one side of the device shaft. On the opposing side of the shaft a bait box is secured. This structure provides the fisher with ready access to bait and tackle. Unlike the present invention, the Chestnut device does not include a tabletop, beverage cup holders, or drawers.

Harding, U.S. Pat. No. 5,054,738 discloses a fishing rod and beverage holder device. The device has two metal rod segments bent in to specific configurations. Outer ends of the rods are curled inward and down to receive fishing rods. The central portion of the rods is the narrowest point of the device, and each is concavely curved to form a beverage container support bracket. Inner ends of each rod are secured to a panel that removably secures of the top of a rail. Using the device, two fusing rods and a beverage container can be supported by a dock railing. The Harding device does not include a table, or any securing drawers.

Another combination fishing rod holder and beverage container holder is disclosed in Fraser et al, U.S. Pat. No. 6,260,697. The Fraser device is a small four sided tray with a beverage container holder disposed at one end. Two ends of a securing strap attach to opposing sides of the tray exterior. The securing strap can be wrapped around or buckled around a post, rail, or other support structure. On one side of the tray are one or more brackets for holding a fishing rod. In this manner, a fisher may hold a fishing rod, snack, and beverage in a confined location. But, the Fraser device does not disclose a table, or storage drawers as the present invention does.

Dysarz, U.S. Pat. No. 5,813,163 discloses a fishing rod holder adapted for attachment to a table, pier, or dock. The fishing rod holder has a T-bar that attaches to a screw located at the lower end of the holder. The T-bar is removed, the screw inserted through a hole in the table, dock, pier, etc., and the et-bar is then screwed onto the end of the screw, on the side of the table opposing the fishing rod holder. Thus the holder is removably mounted to an underlying support structure. Unlike the present invention, the Dysarz fishing rod holder does not include a table, beverage holders, or storage drawers.

These prior art devices have several known drawbacks. They do not provide a collapsible table structure integrated into the fishing rod holder. Nor do the prior art devices provide multiple sliding storage trays. The present invention includes both of these structural features. It substantially diverges in design elements from the prior art and consequently it is clear that there is a need in the art for an improvement to existing fishing rod support devices. In this regard the instant invention substantially fulfills these needs.

### SUMMARY OF THE INVENTION

In view of the foregoing disadvantages inherent in the known types of fishing rod holders now present in the prior art, the present invention provides a new portable table and goods storage wherein the same can be utilized for providing convenience for the user when fishing for an extended length of time

The present invention is a combination table, storage container, and fishing rod holder. The device has a central shaft that is telescopic, to enable height modifications. At a first end of the central shaft is a pointed auger with ribs or threading. This end is screwed downward into sand until the central shaft is sufficiently seated within the ground so as not to wobble or lean. The second end of the central shaft has a receiving cup attached thereto. This cup may have a diameter larger than that of the central shaft or may be roughly equivalent. Table umbrella poses may be retained within the receiving cup, thereby turning the device into a shade provider. Alternatively, a fishing rod can be inserted into the receiving cup and retained therein. The central shaft may be wholly or partially hollow, and an aperture may extend through the bottom of the receiving cup to enable a fishing rod to slide down into the shaft interior.

A tabletop structure with a central cutout secures around the central shaft. The central shaft slides into the aperture in the tabletop and is held in place by a T-bar bracket on the underside of the table. The table is divided into two halves that are hingedly attached in a manner hat enables the table to fold upward together. One half of the table has two drink holder recesses. The other half of the table has two drawers disposed along its underside. When the device I fully deployed, the first end of the central shaft is buried in the sand, the tabletop is folded out to form a planar surface, and a fishing rod may be inserted into the central shaft through the receiving cup.

To aid in portability of the device, a handle is disposed along the central shaft. A series of fastening straps are secured to the bottom of the tabletop. The device is easily stowed by folding the table in half, placing the central shaft along the upper edges of the folded table, and securing the fastening straps around the shaft. The stowed device can then be lifted and carried by the handle on the central shaft. In this manner, the device provides an easy to transport and deploy table, which can be used to hold a fishing rod in between casting and reeling actions.

It is therefore an object of the present invention to provide a new and improved fishing rod holder device that has all of the advantages of the prior art and none of the disadvantages.

It is another object of the present invention to provide a fishing rod holder having the ability to support food and beverage containers.

Another object of the present invention is to provide a fishing rod holder that is easily transported, and rapidly deployed.

Yet another object of the present invention is to provide a means of securing loose items during trips to the beach.

Still another object of the present invention is to provide a fishing rod holder that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention deployed on a beach, with a fishing rod inserted into the central shaft.

FIG. 2 shows a perspective view of the deployed fishing rod holder, without any food or drink items placed on the tabletop.

FIG. 3 shows a perspective view of the deployed fishing rod holder with beverages in the beverage container holders, and loose personal articles stowed in an extended storage drawer.

FIGS. 4 & 5 show opposing side perspective views of the fishing rod holder device in a stowed state.

### DETAILED DESCRIPTION OF THE INVENTION

Reference is made herein to the attached drawings. Like reference numerals are used throughout the drawings to depict like or similar elements of the fishing rod holder device. For the purposes of presenting a brief and clear description of the present invention, the preferred embodiment will be discussed as used for holding articles and retaining a fishing rod or umbrella. The figures are intended for representative purposes only and should not be considered to be limiting in any respect.

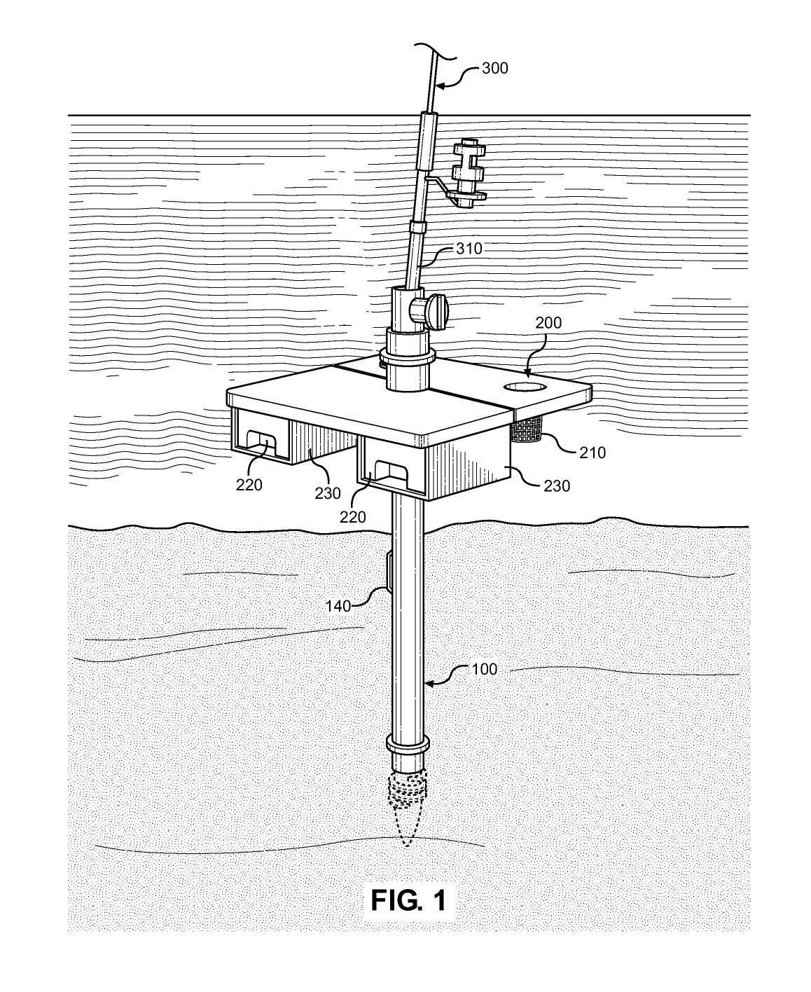

Referring now to FIG. 1, there is shown a deployed fishing rod holder with a tabletop and storage drawers. The device is augered into the sand such that the central shaft 100 is able to bear the weight of the fishing rod 300. Insertion depth necessary to achieve sufficient stabilization of the central shaft will vary according to the soil profile. For this reason, the central shaft is preferably telescoping. Height of the central shaft, and resultantly, the tabletop 200, may be increased or decreased as needed. The tabletop provides a planar upper surface upon which bait may be cut and food items placed. Beverage container holders 210 are recesses extending downward through and below one half of the table. Beverage containers of varying size may be placed within the holders to reduce the risk that they will fall off the table and spill their contents. Along the bottom of the other half of the table are two storage drawers 220. The drawers slide in and out of channels 230 extending downward from the tabletop.

The handle end of a fishing rod, or based of a sun umbrella may be retained within the central shaft of the device. As illustrated, the handle 310 of the fishing rod 300 is retained within a receiving cup 130 disposed at the first end 110 of the central shaft 100. The cup may have a solid bottom, or may have an aperture, providing axis into the hollow interior of the central shaft. It is preferable that the cup has an aperture extending through its bottom, or has no bottom at all, as this would allow the fishing rod handle to slide further down into the central shaft, thereby providing better support. The receiving cup has a protrusion 131 on one side that operably connects a clamping dial 132. This dial is manipulated to increase or lessen pressure exerted on an object within the receiving cup. As will be discussed in more detail herein, variable pressure may be employed to aid in upright retention of a fishing rod or umbrella.

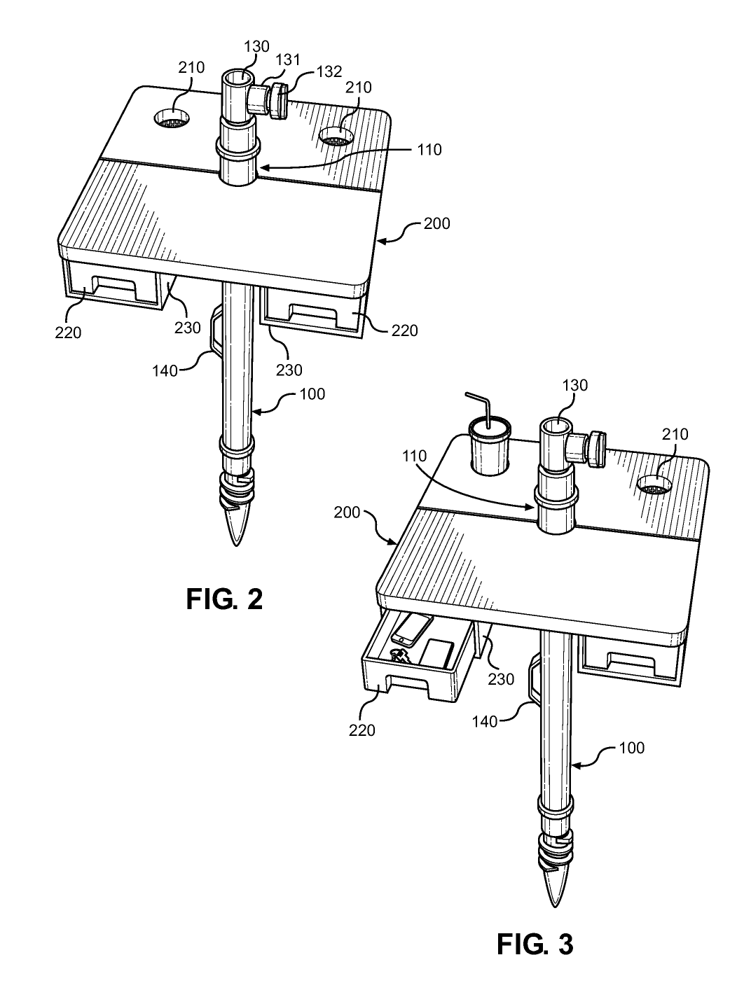

The fishing rod holder device is shown in greater detail in FIG. 2. The central shaft 100 is augered into the sand at its second end (not shown). Exposed portions of the central shaft are held upright if the second end is sufficiently buried within the sand. A handle 140 used for carrying the device when it is in a stowed configuration, protrudes from one side of the central shaft. At the first end 110 a receiving cup 130 is connected to the central shaft. The cup may have it's own bottom, or may simply be an extension portion of the central shaft. The cuff bottom may be solid or alternatively may have an aperture therefore, and sufficiently sized to permit a fishing rod handle to pass through into the central shaft hollow interior.

A protrusion 131 extends from a portion of the receiving cup exterior. The protrusion has a hollow channel extending throughout its length, and houses a tightening mechanism operatively connected to a clamping dial 132. In a simple embodiment, the tightening mechanism may be a threaded bolt secured to the clamping dial. The channel within the protrusion is threaded such that turning the dial screws the threaded bolt into the protrusion, causing the bolt to extend further into the center of the receiving cup. When an object is inserted into the receiving cup, the clamping dial is turned until the threaded bolt exerts sufficient pressure on the object to keep it from wobbling. Alternatively there may be a spring-controlled cuff within the receiving cup, and the cuff's diameter expanded or contracted via the clamping dial. Other forms of exerting pressure within a cylindrical support known to one of ordinary skill in the art may be employed. The purpose of the clamping dial is to enable manipulation of pressure exerted on object retained within the fishing rod holder.

The central shaft itself may be telescoping and thus composed of several nested sections. In one embodiment, each section may have a ridge along its bottom edge such that the ridge prevents the section from being removed from the surrounding section. Depressible tabs may protrude from each section, and be aligned to extend through small apertures in the sections, thereby locking each section in place when deployed. Depression of the deployed tabs pushes them back through the section wall and enables sliding of the two sections held together by the deployed tab. Other forms of telescoping may also be used, as will be known to one of ordinary skill in the art.

A tabletop 200 is supported by a T-bar connection with the central shaft 100. The tabletop has a T-bracket on the tabletop underside. This bracket engages a ridge located on the central shaft exterior and thereby holds the tabletop in position. The tabletop has two halves hingedly connected on the tabletop underside. One half of the tabletop has a plurality of beverage container holders 210 that extend downward from the upper surface to an area below the tabletop. A second half of the tabletop has a pair of channels 230, which extends downward from the underside of the tabletop and house two storage drawers 220. These drawers may slide on rails disposed within the channels or may be simply seated therein. In a preferred embodiment, the storage drawers lockably engage the tabletop or channels via a key lock or combination lock, in order to provide secure storage of items. In other embodiments, the storage drawers and tabletop or channels may have aligning apertures that can receive a third party lock. When a lock is inserted through the aligned apertures, the drawer is inaccessible.

Turning now to FIG. 3, the tabletop is shown in use. A beverage container is inserted into one of the beverage container holders 210. Walls of the container holders may be a solid mesh, may be a cloth mesh, vented solid, or uniformly solid, depending upon intended method of construction. The present invention is not limited to a singular implementation of cup holder design and variations will be apparent to one of ordinary skill in the art.

Storage drawers 220 are disposed within channels 230 that extend downward form one side of the tabletop. As illustrated in the figure, the channels may be rectangular, with rectangularly shaped storage drawers. Other geometrical cross-sections are also contemplated. Each storage drawer has a handle, which may be integrated into the front face of the drawer, or may be attached thereto. The drawers have a tray shape with a hollow interior suitable for placing loose articles such as a wallet, keys, and the like. Because items of value may be stored within the drawers, it is preferable that each drawer has a locking mechanism.

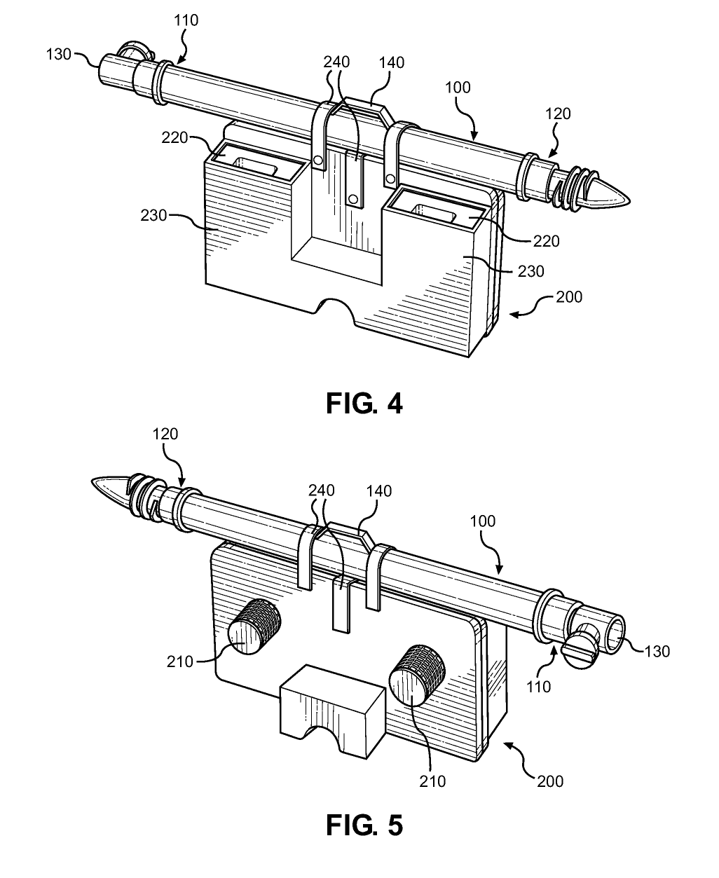

Referring finally to FIGS. 4 & 5, the device is shown in a stowed configuration. The device folds up into an easy to carry stowed state that facilitates conveyance of the device between uses. Hinged connection of the two halves of the tabletop 200 enables folding the tabletop in half for storage. Storage drawer channels 230 and beverage container holders 210 protrude from the underside of the tabletop, making inward rotation about the hinges, towards the tabletop's flat upper surfaces advantageous.

Securing straps 240 may be attached to laterally opposing edges of the tabletop, distal form the hingedly connected edges. These straps are secured across the free edges of the folded tabletop via fasteners such as snaps, hook and loop material, buttons, magnets, or the like. In a preferred embodiment, there are two ore more straps, with some of the straps being substantially longer than the others. The longer straps are secured over both the tabletop edges and the compacted central shaft 100. The handle 140 of the central shaft should be positioned between securing straps when fastened into position to allow the device to be picked up and carried by the handle, while the tabletop hangs down from the central shaft, supported by the securing straps.

The second end 120 of the central shaft 100 has an auger disposed thereon. As depicted in the figures, the auger may be conical in shape, with ribbing to aid in gripping soil. Alternatively the auger may have screw threading, may have a tetrahedronal shape, multiple prongs, or any other suitable for driving into sandy soil. At the first end 110 of the central shaft is the receiving cup 130.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing rod holder device, comprising:
a central shaft having a receiving cup disposed at a first end and an auger disposed at to second end;
a tabletop having two hingeably connected halves, each of said halves having a central half circle cutout such that when said tabletop is deployed, said half circle cutouts align into a single circular aperture sized to receive said central shaft;
a plurality of beverage container holders disposed on a first half of said tabletop;
a plurality of storage drawer channels extending downward from an underside of a second half of said tabletop, wherein two storage drawers are housed within said storage drawer channels;
a securing bracket having a first and second half, wherein said first half is disposed on an underside of said tabletop first half, and said second half of said securing bracket is disposed on an underside of said second half of said tabletop, wherein said first and second halves of said securing bracket clamp around said central shaft when deployed.

2. The fishing rod holder device of claim 1, wherein said auger is conical with ribbing.

3. The fishing rod holder device of claim 1, wherein said receiving cuff further comprises:
a clamping dial, operatively connected to a mechanism that exerts pressure on objects within said receiving cup when said clamping dial is rotated in a first direction, and wherein said mechanism releases pressure on an object within said receiving cup when said clamping dial is turned in an opposing direction.

4. The fishing rod holder device of claim 1, wherein said central shaft further comprises a handle.

5. The fishing rod holder device of claim 1, wherein said central shaft has a hollow interior.

6. The fishing rod holder device of claim 1, wherein said storage drawers have locking mechanisms such that said storage drawers are inaccessible when locked.

7. The fishing rod holder device of claim 1, wherein each of said storage drawers has a handle.

8. The fishing rod holder device of claim 1, further comprising a plurality of securing straps disposed along an underside edge of each of said tabletop halves, wherein said edges are distal from hingeably connected edges of said tabletop halves, and wherein said securing straps fasten to an underside of an opposing tabletop half when said tabletop is folded into a stowed configuration.

9. The fishing rod holder device of claim 1, wherein said beverage container holders extend through said tabletop and protrude downward therefrom.

10. The fishing rod holder device of claim 1, wherein said securing bracket supports said tabletop while in use.
